(19) United States
(12) Patent Application Publication
(10) Pub. No.: US 2023/0008689 A1
(43) Pub. Date: Jan. 12, 2023

(54) SYSTEM TO PROVE SAFETY OF ARTIFICIAL GENERAL INTELLIGENCE VIA INTERACTIVE PROOFS

(71) Applicant: Kristen William Carlson, Concord, MA (US)

(72) Inventor: Kristen William Carlson, Concord, MA (US)

(21) Appl. No.: 17/855,712

(22) Filed: Jun. 30, 2022

Related U.S. Application Data
(60) Provisional application No. 63/216,547, filed on Jun. 30, 2021.

(51) Int. Cl. G06N 5/02; G06N 7/00; G06N 5/04; H04L 9/32

(52) U.S. Cl. CPC G06N 5/022; G06N 7/005; G06N 5/04; H04L 9/3221

(57) ABSTRACT

A method to prove the safety (e.g., value-alignment) and other properties of artificial intelligence systems possessing general and/or super-human intelligence (together, AGI). The method uses probabilistic proofs in Interactive proof systems (IPS), in which a Verifier queries a computationally more powerful Prover and reduces the probability of the Prover deceiving the Verifier to any specified low probability (e.g., 2⁻¹⁰⁰) IPS-based procedures can be used to test AGI behavior control systems that incorporate hard-coded ethics or valuelearning methods. An embodiment of the method, mapping the axioms and transformation rules of a behavior control system to a finite set of prime numbers, makes it possible to validate safe behavior via IPS number-theoretic methods. Other IPS embodiments can prove an unlimited number of AGI properties. Multi-prover IPS, program-checking IPS, and probabilistically checkable proofs extend the power of the paradigm. The method applies to value-alignment between future AGI generations of disparate power.

### CROSS REFERENCE TO RELATED APPLICATIONS

This application claims priority to U.S. Provisional Application No. 63/216,547 filed 30 Jun. 2021, which is herein incorporated by reference in its entirety. To simplify this patent application for the Examiner's and future readers' benefit, the Inventor has omitted mathematical background material in the provisional application, to which interested parties may turn if desired.

### BACKGROUND

### Prior and Related Art

### References

Aharonov, D. and U. V. Vazirani, Is Quantum Mechanics Falsifiable? A Computational Perspective on the Foundations of Quantum Mechanics, in Computability: Turing, Gödel, Church, and Beyond, B. J. Copeland, C. J. Posy, and O. Shagrir, Editors. 2015, MIT Press: Cambridge, Mass. p. 329-349.

Arora, S. and B. Barak, Computational Complexity: A Modern Approach. 2009, Cambridge: Cambridge Univ. Press. 579 pp.

Babcock J, Kramar J, Yampolskiy R. Guidelines for artificial intelligence containment. 2017:13. https://arxiv.org/abs/1707.08476. Accessed 1 Oct. 2018.

Bostrom N. Superintelligence: Paths, Dangers, Strategies. Oxford, England: Oxford University Press; 2016.

Callaghan V, Miller J, Yampolskiy R, Armstrong S. The Technological Singularity: Managing the Journey. The Frontiers Collection. Vol XII: Springer; 2017: https://www.springer.com/us/book/9783662540312. Accessed 21 Dec. 2018.

Collendanchise M, Ogren P. Behavior Trees in Robotics and AI. 2017:198. https://arxiv.org/abs/1709.00084. Accessed Dec. 2, 2018.

Goldwasser, S., et al., The knowledge complexity of interactive proof systems. SIAM Journal on Computing, 1989. 18(1): p. 186-23.

Omohundro S. Autonomous technology and the greater human good. Journal of Experimental and Theoretical Artificial Intelligence 2014; 26:303-315.

Russell, S.J., Human Compatible: Artificial Intelligence and the Problem of Control. 2019, Viking: USA. 336 pp.

Sipser, M., Introduction to the Theory of Computation. 3rd ed. 2012, Boston, Mass.: Course Technology Cengage Learning.

Yampolskiy, R. V., What are the ultimate limits to computational techniques: verifier theory and unverifiability. Phys. Scr., 2017. 92: p. 1-8.

### Definitions

As known to those skilled in the various mathematical, computer science, artificial intelligence, and machine learning arts, the following definitions are used in teaching the present invention.

Intelligence is defined as the ability to solve problems, which may involve the further abilities of setting goals, creating candidate solutions to problems and testing them, and other intelligence abilities known to those skilled in the arts mentioned above. Intelligence herein is defined to include sensory abilities, e.g. vision or the improvement of vision via microscopes, telescopes, infra-red telescopes, long baseline interferometry telescopes, etc.

Artificial general intelligence (AGI) is defined as the ability of an artificial intelligent system to solve problems at or above human ability across different problem domains. Thus, herein (AGI) is defined to include artificial superintelligence, i.e. greater-than-human intelligence. Artificial superintelligence has been shown in various problem domains, some exceedingly complex, such as checkers, chess, go, forms of poker, bridge, computer strategy games, and other domains.

An axiomatic system comprises a set of axioms and rules of derivation or inference, from which theorems are derived as combinations of axioms and rules of inference. The rules of inference are constructed to produce valid, i.e. mutually consistent, theorems from the axioms. Some abstract systems based on language formation rules (“formal systems”) do not distinguish between the axioms and rules of inference.

Behavior. In design intent and in observation, behavior consists of input-output specifications. The complexity of input (I) output (O) combinations is O^{I}.

Behavior Control System (BCS). A method of controlling behavior implemented on a computing machine. The method classifies prescribed and proscribed behaviors via generalized patterns of each along with large numbers of heuristics. The process for enforcing precripted and proscriped behavior is embodied in the software algorithms of the BCS. A behavior tree as used in some computer game software is an example of a BCS.

Values are defined as generalized constraints on AGI behavior. Ethics and morals are examples of values, but values are not limited to ethics and morals. Fundamental values from which an autonomous agent derives decisions via the set of ordered preferences immanent in the values. One way to define values is as nodes that are at or near the base in a behavior structure, such as a tree where the nodes are at or near the roots. Thus, such nodes constrain all the theorems (i.e. behaviors) that derive from them.

Pareto value alignment is defined as a test of an interaction, more generally termed a transaction, between two agents in which neither experiences a transition to a worse state from a better state, where ‘worse’ and ‘better’ are defined subjectively according to each agent's own individual set of values.

Non-Pareto value alignment is defined as a test of an interaction, more generally termed a transaction, between two agents in which either agent may experience a transition to a worse state from a better state, where ‘worse’ and ‘better’ are defined subjectively according to each agent's own individual set of values, but the transaction is constrained by the set of values of a third party (agent).

Morality. Operationally defined as the observable practice of making voluntary, peer-to-peer transactions, as opposed to transactions that are coerced by one of the parties.

Safe AGI. A probabilistic, asymptotic ideal. 1. Aligned with human values. 2. Incapable of malevolent actions toward humans except under prescribed conditions, such as defensive military action.

Utility Function. A utility function, a term of art in economics, is a function relating an ordered set of preferences when an agent employing the function decides to enter a transaction.

### The Problem Statement

The two key problems facing humanity with regard to AGI are, as given in the references cited above:

1) Non-alignment of AGI values and goals with human values to the point where AGI can be dangerous or even pose an existential threat to humanity

2) AGI evolving so quickly, as it will at some point, that it will surpass human ability to monitor and intervene to prevent an AI path of danger to humanity (the “hard takeoff”).

These problems require a solution of aligning AI values with humanity's to the extent that AGI will not take paths that threaten human welfare (in short, “AGI safety”). Many analyses of dangerous paths AGI could take and many proposals to ensure AGI safety have been, and will be proposed, such as in the references cited above. Assume various proposals to ensure AGI safety exist; how do we prove their validity and completeness?

Supporting the novelty of the present invention, it is striking that, while the need for a means to prove AGI safety has been widely acknowledged, indeed, that such a means may be necessary for the survival of the human race, neither the AI workers nor the mathematicians who have at their disposal many proof techniques have provided a means to prove AGI safety, in the references cited above, or in any other source that I have found.

Moreover, arguments questioning in general the ability of an agent of lesser intelligence (such as human) to prove qualities of agents possessing greater intelligence (such as AGI) have been made. And assuring human safety with regard to the first AGI generation is an insufficient solution. In a hard takeoff scenario where the first AGI (AGI¹) rapidly improves its own abilities and each AGI generation in turn creates successor AGI generations (AGI², AGI³, etc.) that are super-intelligent compared to its own ability, each prior generation, as well as humanity, will be at an existential disadvantage to the succeeding one unless its safety is secured. Thus, preventing the first AGI generation from wiping out humanity is insufficient, means to secure safety of all future AGI generations must be created, and means to prove the validity and completeness of the safety technology must be created as well.

### The Fundamental Problem of Asymmetric Technological Ability

A future AGIⁿ will have access to an entire class of algorithmic methods that are more powerful than those of its predecessor generations and humanity, such as quantum computation (QC) versus Church-Turing computation (CT). Currently it is unknown whether QC is truly capable, theoretically or practicably, of fundamentally out-performing classical, Turing Machine-level computation, but the general belief is that in principle, QC can do so, via the ability to encode 2ⁿ states in n spins, i.e. to solve problems requiring exponential scaling in polynomial time.

Further, there exist classes of computation (e.g. #SAT, NODIGRAPH, #P) that are more intractable than those hypothesized to be solvable by QC. Thus, in fundamental computational complexity terms, there are predictable and known bases for future interactions, likely adversarial, between technologically superior and inferior AGI generations.

Ideally, one general framework to prove human-AGI safety and intergenerational AGI safety would be created. With a general proof paradigm, humanity would construct provably safe AGI¹, which would be endowed with the motivation to produce the specific methods to construct and prove safe AGI², etc.

### SUMMARY

The Invention comprises a general paradigm (methods and systems) for mathematically and formally proving properties of AGI such as its valuealignment with humans, and properties such as value-alignment between successive generations of AGI as they evolve. The method and system use probabilistic, interactive proofs consisting of a computationally weaker Verifier validating expressions from a computationally superior and possibly untrustworthy or adversarial Prover. Interactive proofs reduce the probability of falsehood to arbitrarily acceptably low levels.

### BRIEF DESCRIPTION OF THE DRAWINGS

FIG. 1 is prior art detailing the components of a generic interactive proof system (IPS).

FIG. 2 schematically details the innovation of the present invention over prior art IPS show in FIG. 1 in terms of components.

FIG. 3 details the innovation of the present invention over prior art IPS show in FIG. 1 in terms of a process.

FIG. 4A shows a cartoon subset of a far more complex behavior tree. FIG. 4B shows the same FIG. 4A but with each vertex of the behavior tree assigned a sequential unique prime number, to help illustrate an embodiment of the present invention.

### DESCRIPTION OF EMBODIMENTS

### Detailed Description

The reader is assumed to be knowledgeable in computer science, and to understand the concepts of a universal computer (a Turing machine), a deterministic vs. non-deterministic Turing machine, algorithms, and probabilistic algorithms, all of which have historically been referred to, simply, as “machines”. If a machine “accepts” a string from a language, it means it has performed a useful computation.

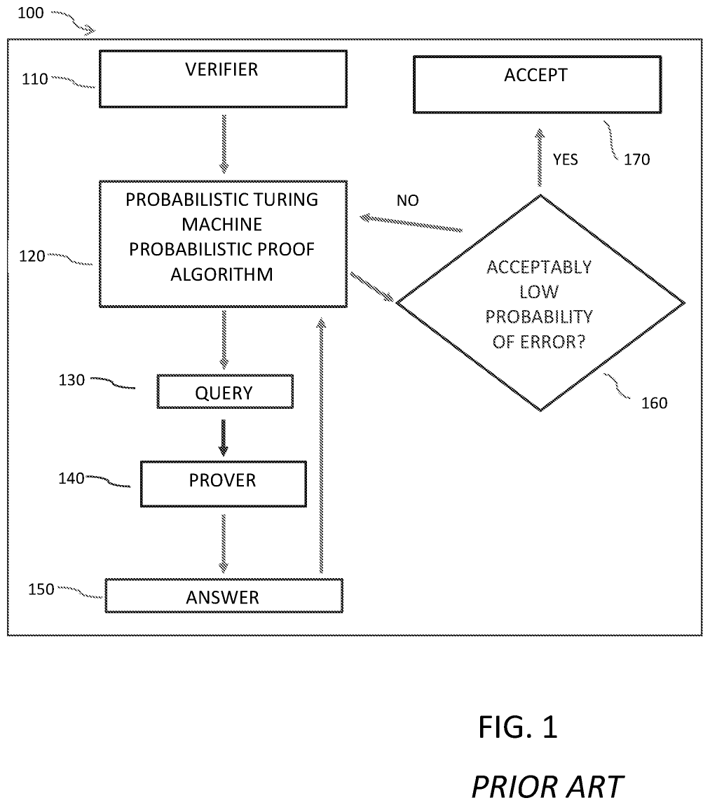

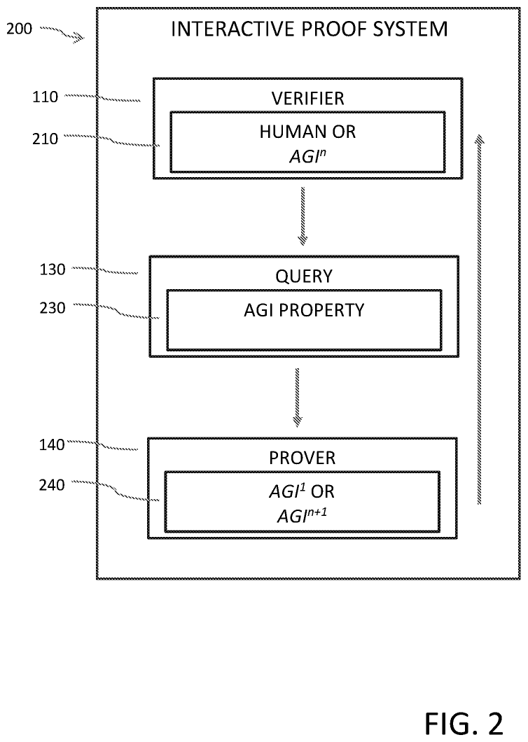

FIGS. 1 and 2 clarify the novelty of the present invention over the prior art. In practice, these systems reside on computation hardware of any nature (e.g. the current solid-state technology, the possible near-future quantum computation technology, or any means of computation that is developed in the future). FIG. 1 shows an assembly 100 comprising a mathematical communication protocol called an interactive proof system (IPS). In the IPS, a Verifier 110 calls a probabilistic Turing machine (PTM) on which is programmed one or more probabilistic proof algorithms (PPA) (PTM/PPA) 120. As known to those skilled in the art, each PPA, given an input string w from a language A designed for the PTM/PPA, recognizes A (meaning it successfully processes A) with a given error probability ϵ such as ϵ between 0 and ½, (0≤ϵ<½), or any stronger condition, such as ϵ not exceeding ⅓. The input string will be a specific instance of a given general problem, for which the PTM/PPA is designed to verify or falsify. If ϵ were 0, the PPA would not be probabilistic, but would give an answer of 100% certainty. But on a single call (a query 130), probabilistic algorithms do not guarantee or reject with 100% certainty the truth of the problem instance supplied to them, but rather, guarantee the truth or falseness of a problem instance with a probability, which is the error ϵ. An error of ⅓ is less than an error of ½.

However, the interesting thing is, when called repeatedly, the PTM/PPA iterates and compounds the error probability, so that over multiple calls, each with a different problem instance, the cumulative error probability converges to any arbitrarily low probability, approaching certainty. The repetition of the PTM/PPA over time is thus called the amplification lemma. Given an error tolerance ϵ of a PTM/PPA machine, we can run it repeatedly (say k iterations) until the desired error tolerance ϵ^{k} has been reached. Thus, even if a particular PTM/PPA has only a 50-50 chance of verifying a given problem instance, if we call it 100 times with different instances of the same problem, which are required to be randomly chosen so that no bias in the instance selection invalidates the calculation of probability of error, the cumulative probability of falsehood is 2⁻¹⁰⁰, which is about 8×10⁻³¹, an extremely low chance of being false. For a machine taking one action per second, this probability amounts to one failure in 100 years. If we want an even lower chance of being wrong, we can just run the PTM/PPA more times until the desired low probability is achieved.

This simple but fundamental property of the prior art is the key to understanding the novel advance of the present invention, and more technical detail of the PTM/PPA is given in the provisional application 63/216,547 and proofs that it works as described, in the literature references that the 547 application cites.

The IPS assembly 100 is based on the PTM/PPA 120. Thus, the Verifier 110 calls the PTM/PPA 120 to send a query 130 to a Prover 140. The Prover 140 generates an answer 150 that is submitted to and processed by the PTM/PPA 120. The PTM/PPA then calls a simple decision procedure 160, which calculates the cumulative probability of error as mentioned. If the probability of error is acceptably low, the decision procedure tells the IPS to enter the accept state 170 and terminate. If the error probability does not meet the required low threshold, the decision procedure 170 calls the PTM/PPA 120 to generate another unique query 130 to submit to the Prover 140, etc., until the desired low probability is achieved.

Turning to FIG. 2, now, another key property of this system is the Prover 140 can have supra-human intelligence, as in its computational, sensory, and other capabilities, while the Verifier 110 may have lesser intelligence and other capabilities than the Prover 140. This is the key to the present invention, in which proofs of certain properties, notably safety and value alignment with regard to humans, of human interaction with the superior intelligence, AGI, may be obtained by the lesser, human intelligence. Within the generic IPS assembly 100, the Verifier now embodies the inferior intelligence of humans or a given AGI generation AGIⁿ, collectively 210, the query 130, in its preferred embodiment is directed toward a query about a property 230 of Prover 140 such as safety or value-alignment with regard to humans, and Prover 140 of superior intelligence embodies the first AGI generation, AGI¹ 240, in the case that the Verifier 110 is human, or embodies a successive AGI generation, AGIⁿ⁺¹ 240, in the case that Verifier 110 embodies a given AGI generation AGIⁿ, where n can be 1, 2, 3, etc. To illustrate the disparity in intelligence between lesser-intelligent human or AGI Verifier 210 and greaterintelligent Prover 240, lesser-intelligent agent 210 may be operating with inferior algorithms limited to the computational categories of PSPACE and PTIME and with current scientific knowledge and methods, while the computational resources and knowledge and methods of greater-intelligent Prover 240 may be vastly greater than those of the Verifier 210 and indeed, incomprehensible to Verifier 210.

In more general embodiments than the preferred, the IPS 100 may be used by lesser-intelligent Verifiers 210 to submit queries 230 to greater-intelligent Provers 240, queries whose subject is more general concerning Verifier's 210 universe, meaning any aspect of Verifier's 210 environment, such as about the origins of the universe, the Creator of the universe, how to extend healthy lifespan, how to end war or poverty, how to organize the economic system to achieve optimal opportunity for every human or AI agent, how to form an optimal government to optimally achieve maximum human happiness, etc. In sum, the present invention described in terms of its components in the IPS process is assembly 200.

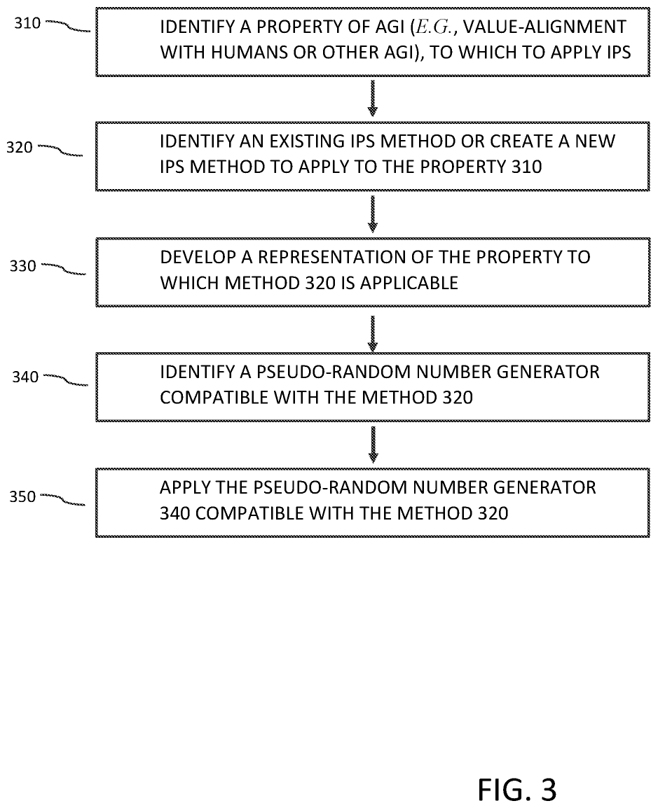

FIG. 3 describes the innovation of the present invention over prior art in terms of a different process, that of creating an IPS to apply to proving human-AGI safety or other desired property. We first outline the abstract steps of the process 260 and then give examples to help teach the art. The references cited above also give historical examples of how new IPS methods and applications were created.

The first step 310 is to identify the property of AGI, such as its safety or value-alignment with regard to humans, for which a proof is desired. In the second step 320, we must identify an existing IPS method (of which there are many) or if no existing IPS method seems to apply, create a new IPS method, to which to apply to proving the property identified in step 310. For instance, there have been examples where workers were able to take a deterministic proof of a property of numbers and innovate a probabilistic proof from it that could be used in a specific IPS. In the third step 330, we must create a representation of the property 310 to which method 320 is applicable. Next, step 340, we must find or create a pseudorandom number generator (PRNG) that is compatible (see the references) with the representation 330. Last, step 350, we must apply the PRNG to the IPS process in the random selection of problem instances to prove probabilistically.

Many additional embodiments of the present invention are possible. For instance, various mathematical techniques that have been added to the general IPS can be employed. For example, multiple prover IPS employ more than one Prover and restrict the Provers from communicating with each other so they cannot conspire to coordinate their answers to the Verifier and in so doing deceive the Verifier.

Similarly, after the invention of IPS workers considered that it is not simple and straightforward to create a perfect random number generator in order to select problem instances randomly, as noted above. Accordingly, random number generators are called “pseudo random number generators” (PRNG). Thus, various methods to ensure higher fidelity uniformly random number distributions from a PRNG were invented, such as “weakly-random sources” and uses of the “seed” that is the initial condition of the PRNG, among others. Each of these methods used in the IPS at the heart of the present invention constitutes an additional embodiment.

Another embodiment example is the use of IPS to effect “zeroknowledge proofs”, which prove a certain property of a system to a certain probability but without revealing the details of the property. As an example, a human Verifier 210 may query 230 an AGI Prover 240 about a weapon the AGI 240 possesses, in which process the AGI 240 may prove the existence of the weapon, without revealing details of its workings or manufacture. Or the roles may be reversed, in which the Verifier 210 may be an AGI and the Prover 240 may be the human, so as to not reveal to the AGI Verifier 210 details of a technology that the human Prover 240 may possess.

As the history of IPS shows, each IPS method rests on one or more mathematical proofs about properties of mathematically-described entities. Thus, where we can create a usage of such a proof to apply IPS to a potential problem in human-AGI or AGIⁿ-AGIⁿ⁺¹ interaction such as ensuring safe interaction, such an application is an additional embodiment of the invention. FIG. 3 illustrates this procedure, which constitutes another description of the present invention innovation over prior art.

In step 310, we must identify a property of AGI, such as value-alignment, to which to apply the IPS. Step 320: Identify or create an IPS method to apply to the property 310. Step 330: Develop a representation of the property to which method 320 is applicable. Step 340: Identify a pseudo-random number generator (PRNG) compatible with method 320. Step 350: Apply PRNG 340 to select random problem instances to prove probabilistically. All these steps are necessary 310 and sufficient to apply an IPS to proving an AGI property. Steps 2 and 3 may occur in reverse order.

Here are a couple of examples to clarify the process FIG. 3 describes.

### Detection of Behavior Control System (BCS) Forgery Via Acrylic Graphs

A single heuristic, such as ‘terminate all humans’, or ethic, such as ‘terminate all agents using resources inefficiently as defined by the following metric’, added to a BCS could result in realization of the AGI existential threat, as could universal drives causing AGI to alter its utility function. Thus, any alteration, especially forgery, of ethics modules or BCS must be detected. One security measure is to store ethics modules, along with other critical AGI components, in a distributed ledger, perhaps distributed among all earlier autonomous agent generations since they all have a proprietary interest in the security and integrity of those components.

If we represent an AGI behavior control system (BCS) as a directed acyclic graph, such as an AI behavior tree with no loops, a unique labeling procedure exists for the nodes and edges as do BPP tests for equivalence of two such structures, although in general the problem is currently intractable (coNP-complete). Equivalence here means the two BCS programs produce the same functions. BPP tests can be used to detect forgery by comparing a reference copy of the BCS stored in a distributed ledger versus a copy presented by a potential adversary. Here we apply an existing BPP procedure to compare two read-once branching programs B₁ and B₂ where F is a finite field with at least 3m elements, and in so doing, detect forgery if it exists. The representation requires an assignment of polynomials to the graph nodes and edges.

Human or AGIⁿ Verifier 210 selects elements aᵢ through aₘ randomly from F.

AGI¹ (if Verifier is human) or AGIⁿ⁺¹ (if Verifier is AGI¹) Prover 230 evaluates the assigned polynomials p₁ and p₂ at a₁ through aₘ.

If p₁(a₁, . . . , aₘ)=p₂(a₁, . . . , aₘ), Verifier 210 accepts, otherwise, rejects.

### Program-Checking Via Graph Nonisomorphism

IPS 200 can be used as a probabilistic check for buggy outputs of programs by running one program P, such as a copy of an AGIⁿ behavior control subroutine, on a machine, the Checker C. Assume the Prover 240 runs a program P that states that two uniquely-labeled graphs are isomorphic P(G₁,G₂). The procedure is (1) the Verifier 210 repeatedly permutes labels of one of {G₁,G₂}, chosen randomly, and (2) asks the Prover 240 if they are still isomorphic, a problem suspected to be NP-complete. The Prover 240 supplies the permutation as the witness, which can be checked in PTIME A guess has a 50-50 chance of being correct. Thus, with k iterations of the procedure the probability of error is 2^{-k}.

### Axiomatic System Representations

In principle, an axiomatic system comprising a language, axioms, and transformation rules can be described formally, and therefore, precisely.

Here we extend existing methods using an arithmetization of the axioms and composition rules (e.g. transformation or inference rules). The desired representation needs to be expressive enough to apply one or more desired number-theoretic theorems to it (more expressive than Presburger or Robinson arithmetic). Thus, we need a finite group of primes, infinite composites of the finite set, and infinite numbers that are relatively prime to the finite set.

Given an axiomatic system of finite axioms and rules and infinite compositions:

Axioms A={a₁, a₂, a₃, . . . , aᵢ}

Transformation rules R={r₁, r₁, R₁ . . . , rⱼ}

Compositions of axioms and inference rules C={c₁, c₂, c₃, . . . , cₖ}. e.g.

(a₁, a₂)·r₁→c₁

(a₂, a₃, a₄)·r₂→c₂,

etc., in which the symbol “·” represents a valid syntactical composition resulting in well-formed formulas (wff) in infix notation, all of which are known to practitioners in the art of working with axiomatic system representations. The first composition example shows a binary transformation rule such as modus ponens from propositional logic while the second composition shows a general n-ary (in this case ternary) rule such as a sequence node testing 3 child nodes in a behavior tree.

All formulae representing all behaviors B are only expressible by the system if they are derivable by a composition of the axiom sets A and the rule sets R:

{A·R}→B.

If we allow loops to express repetitive behavior, a loop may be examined with finite methods either by looking at an entire behavior sequence up to a point in time, or by inductive methods otherwise.

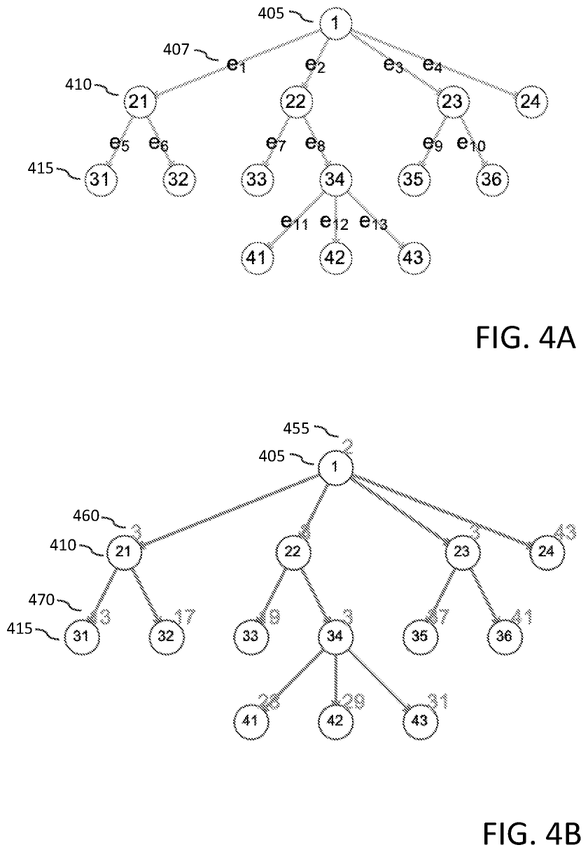

We assign a unique prime number p to each axiom a and transformation rule r, for intelligibility separating axioms and transformation rules (symbolically illustrated in Table 1 and with a more specific example in FIG. 4).

TABLE 1
Arithmetization of an axiomatic behavior control system.

| Syntactical symbol | Prime | Model |
|---|---|---|
| a1 | p1 | 2 |
| a2 | p2 | 3 |
| a3 | p3 | 5 |
| . . . | . . . | . . . |
| an | pn | pn |
| r1 | pn + 1 | pn + 1 |
| r2 | pn + 2 | pn + 2 |
| r3 | pn + 3 | pn + 3 |
| . . . | . . . | . . . |
| rn | pm | pm |

FIG. 4A is a schematic robot behavior tree (BT) with typical numbering of vertices and edges from the literature, excerpted as a minute portion of a large and complex AGI behavior control system. For simplicity and clarity we label only as needed to illustrate the parts. The vertices, for example 405 (1) and 410 (21), represent predefined behaviors. The edges, for example 407 (e1), define which predefined behaviors derive from which other predefined behaviors.

Each vertex is numerically coded for a given sample robotic BT algorithm drawn from the literature: 1: Fallback. 21, 22, 23, 34: Sequence. 41, 42: Condition. Vertex codes for lower-level BT algorithms: 31: Human approaching? 32: Maintain prescribed safe distance. 33: Human asks for help with task. 41: Begin log. 42: Is task moral? 43: Is task ethical? 35: Low energy? 36: Seek power station. 24: Wander.

FIG. 4B shows the same BT as in FIG. 4A but with the innovation within the present invention of assigning prime numbers (gray) to each vertex representing vertex algorithms. We omit edge labels, e.g. 407, e1, in FIG. 4B as irrelevant or confusing to understanding the art and unnecessary clutter. Vertex 1, 405, is assigned the first prime number, 2 (labeled 455). In turn each vertex is sequentially assigned a unique prime number. Vertex 21, 410, is assigned the second prime number, 3 (labeled 460) and each succeeding vertex is assigned a successive prime number in turn. Thus, the trajectory to the behavior test is described by the sequence (2, 3, 3, 31) and composite 2×3×3×31=558.

In this arithmetical representation, transformation rules taking two or more parameters are interpreted as composing the parameters with the transformation rule, i.e., multiplying the primes (axioms) or composites (formulae) instantiating the parameters along with the transformation rule. Then formulae derived within the system, which represent theorems or behaviors, constitute composite numbers, as can be proved by induction. Permitted behaviors are represented by theorems, that is, formulae not relatively prime to the axioms and transformation rules (i.e., composites). Proscribed, forbidden, unsafe behaviors are formulae representing numbers that are relatively prime to the axioms and transformation rules. In general, any axiomatic system specifies a set of constraints that its theorems satisfy [38].

The goal is to render the derived set of behaviors susceptible to the methods of BPP and IPS by reduction via arithmetization. Thus, we only need to capture properties that allow application of IPS. We do not need to represent all of number theory or use the full Godel arithmetization scheme to show incompleteness.

By the unique factorization theorem, this representation uniquely describes trajectories through the tree of axioms, rules, and formulae:

Unique factorization theorem. Every integer a either is 0, or is a unit +/−1, or has a representation in the form

a=up₁p₂ . . . pₙ, (6)

where u is a unit and p₁, p₂, . . . , pₙ are one or more positive primes, not necessarily distinct. The representation (3) is unique except for the order in which the primes occur.

In other words, each sequence uniquely describes a trajectory through a BCS tree, though the order in which the primes occur, i.e., the order of application of each axiom or rule in generating a behavior, is lost when multiplying permitted multiple instances of each axiom or rule together to get the typical factorization representation of a composite with exponents:

cᵢ=pₑ₁_{₁}, pₑ₂_{₂}, . . . , pₙₑ_{ₙ}. (5)

However, the non-uniqueness is irrelevant when testing for compositeness vs. primality.

### Broadening Language

Please understand that although the invention has been described above in terms of particular embodiments, the foregoing embodiments are provided as illustrative only, and do not limit or define the scope of the invention. Various other embodiments, including but not limited to the preceding, are also within the scope of the claims. Notably, the embodiments may be deployed on any hardware or software architecture invented by humans or AI, such as quantum computers, or more advanced hardware invented by humans, humans with augmented intelligence, or AGI.

I claim:

1. An interactive proof system comprised of a verifier in turn comprised of one or a plurality of humans and a prover in turn comprised of one or a plurality of AGIs.

2. The system of claim 1, wherein said proof is directed toward safety of said humans with regard to behavior of said AGIs.

3. The system of claim 2, wherein said proof comprises the means to prove or disprove that a property can derive from a behavior control system.

4. The system of claim 3, wherein said behavior control system further comprises a behavior tree.

5. The system of claim 1, wherein said interactive proof system further comprises a multiple-prover interactive proof system.

6. The system of claim 1, wherein said interactive proof system comprises a means to approach a uniform random distribution from which random numbers are selected.

7. The system of claim 1, comprising a proof that is a zero-knowledge proof.

8. The system of claim 7, in which the roles of human and AGI are reversed, comprising a human prover and an AGI verifier.

9. The system of claim 1, further comprising a means to detect forgery of a behavior control system via mathematical properties of directed acyclic graphs.

10. The system of claim 1, wherein said interactive proof system further comprises a means to perform program-correctness-checking.

11. The system of claim 10, wherein said program-correctness-checking means further comprises a means to detect graph non-isomorphisms.

12. The system of claim 3, further comprising a means to map said behavior control system onto a set of axioms and transformation rules.

13. The method of claim 1, further comprising the steps:
a. identifying a property of AGI that is desired to prove,
b. identifying an interactive proof system method to which to apply to proving said AGI,
c. creating a representation of said AGI property to which said interactive proof system method is applicable,
d. identifying a pseudo-random number generator that is compatible with said representation,
e. applying said pseudo-random number generator to the interactive proof system process in the random selection of problem instances to prove probabilistically,
whereby said interactive proof system is rendered able to prove said AGI property.

14. The method of claim 1, further comprising the steps:
a. assigning a unique prime number to each of said axioms and transformation rules,
b. identifying a derivative behavior as an ordered composition of said prime numbers,
c. testing whether any behavior, represented by a composite number, is a valid derivative of said axiom and transformation rules, by factoring said composite number, whereby said method is enabled to prove whether a specified behavior can be derived from a given behavior control system represented as axioms and transformation rules.
